(19) United States
(12) Patent Application Publication
(10) Pub. No.: US 2026/0353321 A1
(43) Pub. Date: Nov. 5, 2026

(54) METHODS, ARCHITECTURES, APPARATUSES AND SYSTEMS FOR INTER-RAT DOWNLINK CONTROL RESOURCE SHARING IN MULTI-RAT SPECTRUM SHARING CELL

(71) Applicant: InterDigital Patent Holdings, Inc., Wilmington, DE (US)

(72) Inventors: Aata El Hamss, Laval (CA); Tao Deng, New York, NY (US); Remun Koirala, London (GB); Paul Marinier, Brossard (CA); Moon IL Lee, Melville, NY (US); Janet Stern-Berkowitz, Little Neck, NY (US)

(21) Appl. No.: 19/198,501

(22) Filed: May 5, 2025

(51) Int. Cl. H04W 56/00; H04W 16/14; H04W 24/08; H04W 72/231

(52) U.S. Cl. CPC H04W 56/0015; H04W 16/14; H04W 24/08; H04W 72/231

(57) ABSTRACT

Procedures, methods, architectures, apparatuses, systems, devices, and computer program products for inter-RAT downlink control resource sharing are provided. One method may include detecting a synchronization signal block (SSB) associated with a first radio access technology (RAT), determining, based on a first indication indicated in the SSB, first control channel configuration information associated with receiving a control channel transmission of the first RAT, determining, based on the first control channel configuration information and a second indication in the SSB, second control channel configuration information associated with receiving a control channel transmission of a second RAT, and receiving, based on the second control channel information, the control channel transmission of the second RAT.

### FIELD

Example embodiments described in the present disclosure are generally directed to the fields of communications, software and encoding, including, for example, to methods, architectures, apparatuses, systems related to downlink control resource sharing between radio access technologies (RATs).

### BACKGROUND

The deployment of a new radio access technology (RAT) generation may require the acquisition of a new spectrum and is considered one of the major investments for mobile operators. Therefore, it may be desirable to reuse the spectrum from the existing or previous RAT generation as much as possible to reduce the costs associated with deploying the new generation of RAT.

### SUMMARY

An embodiment may include a method for inter-RAT downlink control resource sharing. The method may include detecting a synchronization signal block (SSB) associated with a first radio access technology (RAT), and determining, based on a first indication obtained from or based on the SSB, first control channel configuration information associated with receiving a control channel transmission of the first RAT. The method may also include determining, based on the first control channel configuration information and a second indication obtained from or based on the SSB, second control channel configuration information associated with receiving a control channel transmission of a second RAT, and receiving, based on the second control channel information, the control channel transmission of the second RAT.

An embodiment may be directed to a wireless transmit/receive unit (WTRU) including circuitry, such as a processor and/or transceiver, configured to detect a synchronization signal block (SSB) associated with a first radio access technology (RAT), and determine, based on a first indication obtained from or based on the SSB, first control channel configuration information associated with receiving a control channel transmission of the first RAT. The circuitry may also be configured to determine, based on the first control channel configuration information and a second indication obtained from or based on the SSB, second control channel configuration information associated with receiving a control channel transmission of a second RAT, and receive, based on the second control channel information, the control channel transmission of the second RAT.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates an example diagram depicting additional monitoring occasions for the second RAT, according to an embodiment;

FIG. 3 illustrates a flow diagram of a method, according to certain embodiments; and

FIG. 4 illustrates a flow diagram of a method, according to certain embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

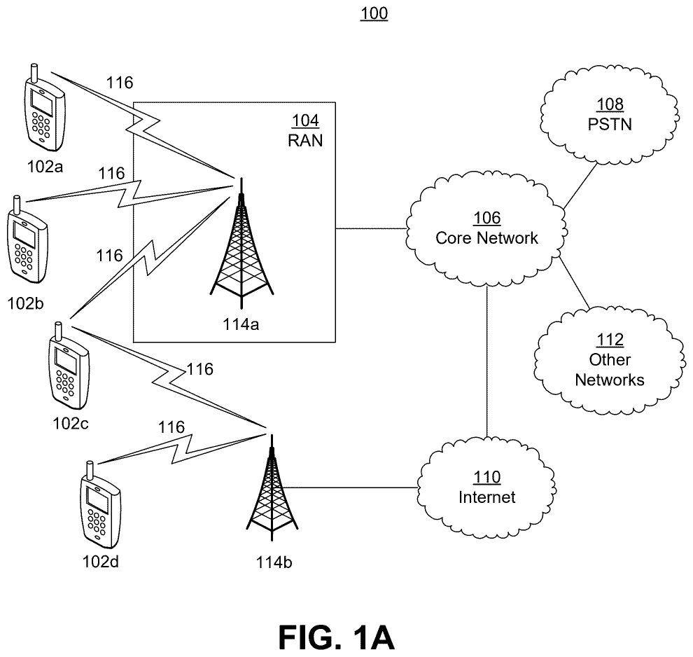

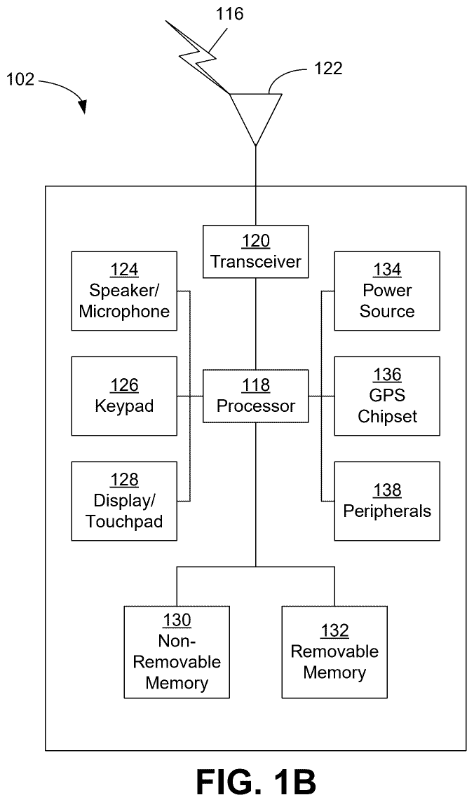

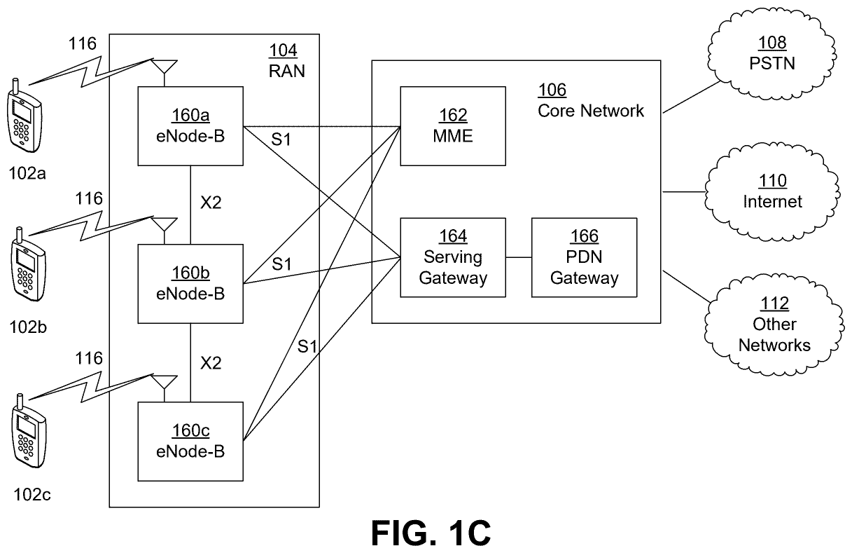

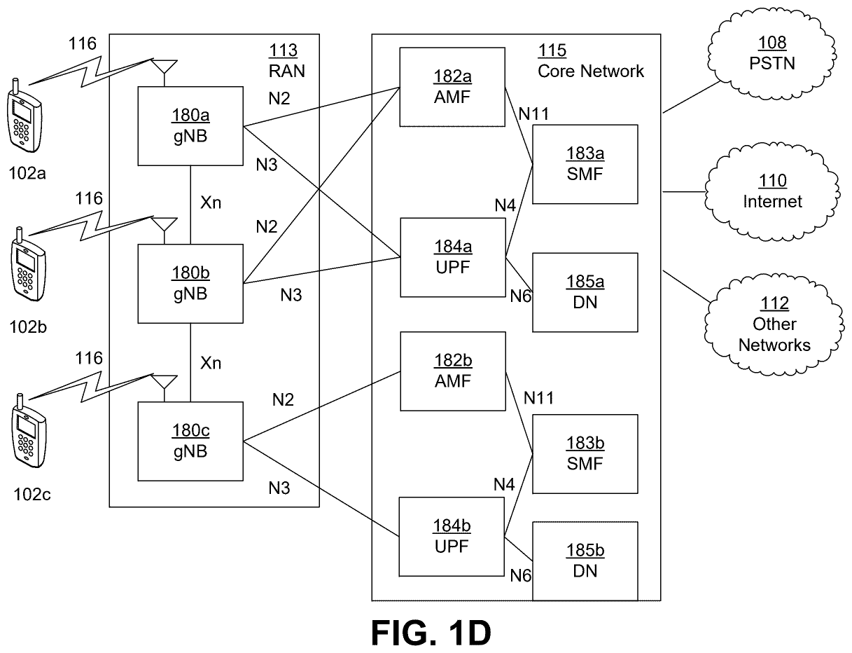

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d, or any other WTRU mentioned or described herein, may be interchangeably referred to as a UE or vice versa.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHZ, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Embodiments disclosed herein are representative and do not limit the applicability of the apparatus, procedures, functions and/or methods to any particular wireless technology, any particular communication technology and/or other technologies. The term network in this disclosure may generally refer to one or more base stations or gNBs or other network entity which in turn may be associated with one or more Transmission/Reception Points (TRPs), or to any other node in the radio access network.

It is noted that, throughout example embodiments described herein, the terms “base station”, “seving base station”, “RAN,” “RAN node,” “Access Network,” “NG-RAN,” “gNodeB,” and/or “gNB” may be used interchangeably to designate any network element such as, e.g., a network element acting as a serving base station. It should be understood that embodiments described herein are not limited to gNBs and are applicable to any other types of base stations.

Moving to a new radio access generation may require the acquisition of a new spectrum and is a major investment for mobile operators. Therefore, it would be desirable to reuse the spectrum from the previous or existing generation to the extent possible to reduce costs. For example, NR can be deployed in some of the LTE bands. To enable the coexistence between the two RATs, the 5G scheduler can avoid scheduling transmissions on the LTE resources. Some of the LTE resources are always present (e.g., LTE CRS) and thus are always excluded from 5G transmissions. The 5G WTRU is pre-configured with a set of resources that are assumed to be reserved (e.g., for LTE transmissions). In this case, the 5G WTRU rate matches around the LTE resources when it receives a downlink transmission overlapping with the reserved resources.

Multi-Rat spectrum sharing (MRSS) is a key requirement for 6G that enables 5G and 6G coexistence. Unlike LTE, 5G does not have always-on signals and almost every 5G downlink signal and/or channel can be transmitted in a flexible manner (e.g., transmission time and/or frequency are flexible in the 5G specification).

To maximize resource sharing between 5G and 6G, the resources (e.g., all resources) should be subject to inter-RAT sharing. For example, the resources allocated for downlink control signaling for each RAT can be shared with the other RAT. Depending on the number of WTRUS in each RAT, the scheduler can allocate more downlink resources to one of the RATs. A problem arises as to how to enable the sharing of control resources between different RATs (e.g., 5G and 6G).

Some embodiments described herein may relate to or may apply multi-RAT spectrum sharing (MRSS). For example, certain embodiments may relate to downlink control resource sharing between a first RAT and a second RAT, e.g., during initial access (e.g., between a 5G and 6G RAT during initial access).

In an embodiment, as discussed in more detail below, a WTRU may be configured to determine the downlink control resources for the second RAT (e.g., 6G downlink control resources) based on an initial control resource set (CORESET) and search space set configuration for the first RAT (e.g., 5 G CORESET #0 and 5G search space set #0 configuration) for a MRSS cell.

In an embodiment, as discussed in more detail below, the WTRU may be configured to determine additional monitoring occasions for the downlink control resources for the second RAT, e.g., based on dynamic sharing indication from the network.

In an embodiment, as discussed in more detail below, the WTRU may be configured to receive a random-access response (RAR) for the second RAT (e.g., 6G) using the downlink control resources and/or downlink control channels of the first RAT (e.g., 5G).

In an embodiment, as discussed in more detail below, a WTRU may be configured to select a SSB type (pre)configured for and/or associated with a (pre)configured WTRU channel condition and/or coverage level.

According to certain embodiments, a WTRU may be configured to monitor and/or detect a synchronization signal block (SSB) for a first RAT in a frequency range (e.g., a 6G WTRU may be configured to monitor and detect 5G SSB in a frequency range).

In an embodiment, the WTRU may detect a SSB associated with the first RAT. For example, the WTRU may detect the SSB of the first RAT and decode the master information block (MIB) transmitted in the physical broadcast channel (PBCH) within the SSB of the first RAT.

In an embodiment, the WTRU may determine, e.g., based on the SSB of the first RAT, a first indication and/or a second indication. For example, the first indication and/or second indication may be included in the MIB of the SSB or may be otherwise obtained or indicated, as discussed elsewhere herein (e.g., may be included in another information block or transmission).

In an embodiment, the WTRU may determine, based on cell access information in the SSB of the first RAT (e.g., cell access information that is indicated or included in the SSB associated with the first RAT), that a cell from which the SSB was received supports multi-radio access technology (RAT) spectrum sharing (MRSS) between the first RAT and a second RAT. For example, the WTRU may determine, e.g., based on a bitfield indication in the MIB, that the cell supports MRSS between two RATs i.e., first and second RAT (e.g., the cell supports using spectrum sharing between 5G and 6G RATs).

In an embodiment, the WTRU may determine, based on the first indication, first control channel configuration information associated with receiving a control channel transmission of the first RAT. For example, the WTRU may determine first control channel configuration information, such as time and frequency information, for receiving a control channel (e.g., CORESET #0 and search space set #0 configuration) of the first RAT based on the first indication in the MIB.

In an embodiment, the WTRU may determine, based on the first control channel configuration information and the second indication, second control channel configuration information associated with receiving a control channel transmission of the second RAT. For example, the WTRU may determine second control channel configuration information, such as time and frequency information, for receiving a control channel (e.g., configuration of CORESET #0 and search space set #0) of the second RAT based on the first control channel configuration information (of the first RAT) and a second indication in the MIB.

As an example, the second indication (e.g., in the MIB) identifies at least one of (e.g., directly or by providing a pointer to an entry in a list or table): a frequency offset, a shared number of PRBs, a shared number of symbols, and/or a time offset.

For example, the WTRU may determine a frequency start of the CORESET associated with the second RAT based on an offset from a frequency start of the CORESET associated with the first RAT (e.g., the WTRU may determine the frequency start of the second RAT CORESET #0 by adding an offset (e.g., the frequency offset) to the frequency start of the first RAT CORESET #0).

For example, the WTRU may determine the number of physical resource blocks (PRBs) of the CORESET associated with the second RAT based on the number of PRBs of the CORESET associated with the first RAT and a shared number of PRBs (e.g., the WTRU may determine the number of PRBs of the second RAT CORESET #0 by subtracting the number of PRBs of the first RAT CORESET #0 from the shared number of PRBs).

For example, the WTRU may determine the symbol duration of the CORESET associated with the second RAT based on the number of symbols of the CORESET associated with the first RAT and a shared number of symbols (e.g., the WTRU may determine the symbol duration of the second RAT CORESET #0 by subtracting the number of symbols of the first RAT CORESET #0 from the shared number of symbols).

For example, the WTRU may determine monitoring occasions for the search space set associated with the second RAT based on a time offset from monitoring occasions for the search space set associated with the first RAT (e.g., the WTRU may determine the monitoring occasions for the second RAT search space set #0 by applying the time offset to the monitoring occasions of the first RAT search space set #0).

In an embodiment, the WTRU may receive, based on the second control channel information, the control channel transmission (e.g., PDCCH transmission) of the second RAT (e.g., in the second RAT search space set #0 and/or using the second RAT CORESET #0). For example, in some embodiments, the WTRU may monitor for a control channel transmission, such as a PDCCH transmission, based on the second control channel information (e.g., using the second RAT search space set #0 and/or the second RAT CORESET #0) and additional indicated monitoring occasions, if any.

As a result, certain embodiments described herein can improve and/or maximize the resource sharing between two RATs by enabling the sharing of downlink control resources.

The term configuration may correspond to one or more indications of one or more parameters, or similar, that a WTRU may receive. The one or more parameters may configure one or more WTRU functions, WTRU methods, WTRU procedures, etc. The WTRU being configured with a parameter may correspond to the WTRU receiving a configuration (e.g., receiving configuration information) comprising an indication of a value of the parameter.

Configuration may correspond to an initial configuration, but also to a reconfiguration. A reconfiguration may change, add, remove, etc., parameters in a previously received configuration.

A configuration may be received with radio resource control (RRC) signaling, e.g., in one or more RRC message(s), e.g., over RRCSetup, RRCResume, RRCReconfiguration, RRCReestablishment, and/or any other RRC message(s).

A configuration may be received with medium access control (MAC) signaling, e.g., in one or more MAC message(s). For example, MAC signaling may apply ASN.1 encoding and/or may be comprised of MAC control messages, or may be used in the form of MAC CEs (Control Element). A MAC signaling message or MAC control message may be distinct from MAC CEs.

The WTRU may receive a configuration (e.g., receive configuration information) in one or more messages. A message carrying a configuration may comprise RRC signaling and/or MAC signaling.

The WTRU may receive a configuration (e.g., configuration information) from a network. In some cases, a first part of a WTRU's configuration parameters may be received with RRC signaling and a second part of the UE's configuration parameters may be received with MAC signaling. For example, the first part may comprise parameters related to functionality common to one or more distributed units (DUs) associated with a central unit (CU), wherein the DU and CU may be network entities. Hence, the CU may indicate the first part to the WTRU, e.g., using RRC signaling. The second part may comprise parameters related to functionality that may be controlled by the DU. Hence, the WTRU may receive the second part from one or more DU(s), e.g., using MAC signaling. In another example, a WTRU may receive configuration information from both CU and DU with RRC signaling. In yet another example, a WTRU may receive configuration information from both CU and DU with MAC signaling.

A resource element group (REG) is a group of resource elements of the resource grid of a carrier/bandwidth part. A control channel element (CCE) can include multiple REG. A CCE-to-REG mapping configuration indicates to the WTRU how REG are grouped to form a CCE.

The WTRU can be configured with one or multiple control resource set (CORESET). A CORESET includes frequency and time resources, e.g., set of Resource Block(s) (RBs) and a set of symbols and/or slots. The WTRU can be configured with a CORESET that have contiguous set of RBs. Alternatively, the WTRU can be configured with a CORESET that have non-contiguous set of RBs. The WTRU can be configured with a CORESET that have contiguous set of symbols and/or slots. Alternatively, the WTRU can be configured with a CORESET that have non-contiguous set of slots/RBs. In some embodiments, a CORESET can be configured within a single carrier (i.e., the frequency resources of the CORESET are within a single carrier). In another embodiment, a CORESET can be configured within multiple carriers (i.e., the frequency resources of the CORESET are within a multiple carriers).

The WTRU can be configured with a CORESET during cell access and/or initial access procedure denoted by CORESET 0. The WTRU can receive downlink control signalling (e.g., DCI) in the CORESET 0 to schedule the cell broadcasted system information (e.g., SIB), random access response (RAR), system information update, paging indication or information, and/or group common information (e.g., dynamic TDD configuration, slot format configuration, sub-band full duplex configuration).

The WTRU can be configured with one or multiple search space sets. A search space set can be associated with one or multiple CORESET(s). When the WTRU is configured with a search space set that is associated with multiple CORESETs, the WTRU monitors the search space set in the multiple CORESETs, i.e., the same search space set is applied to different CORESET. For example, the WTRU may be configured with two CORESET(s), where a first CORESET is configured in a first set of RBs and the second CORESET is configured in a second set of RBs. The WTRU may be configured with a search space set with a monitoring periodicity of pl and number of PDCCH candidates N1 and it is associated with first and second CORESETs. The WTRU monitors the search space set in the first and second set of RBs with periodicity of pl and number of candidates N1 in each CORESET. When the WTRU is configured with a search space set that is associated with a single CORESET, the resource elements (e.g., all the resource elements) of the search space set belong to (e.g., only to) the single CORESET.

The WTRU can be configured with a search space set during cell access and/or initial access procedure (e.g., an initial search space set), which may be denoted by search space set 0. The UE can be configured to associate search space set 0 to CORESET 0. The UE can receive downlink control signalling (e.g., DCI) in the search space set 0 to schedule the cell broadcasted system information (e.g., SIB), random access response (RAR), system information update, paging indication/information, and/or group common information (e.g., dynamic TDD configuration, slot format configuration, sub-band full duplex configuration).

The WTRU can be configured to monitor one or multiple physical downlink control channel (PDCCH) candidates in a search space set. A PDCCH candidate can occupy one or multiple control channel element(s) (CCEs). The WTRU can be configured with aggregation level (AL) for each PDCCH candidate. The AL indicates to the WTRU how many CCEs belongs to the PDCCH candidate. When a PDCCH candidate has one AL, the PDCCH candidate occupies one CCE. When a PDCCH candidate has two ALs, the PDCCH candidate occupies two CCEs. More generally, when a PDCCH candidate has N aggregation levels, the PDCCH candidate occupies N CCEs.

According to some embodiments, as discussed in the following, a first RAT may refer to 5th generation (5G) of mobile communication and a second RAT may refer to the 6th generation (6G) of mobile communication. In other words, 5G RAT may refer to the first RAT and 6G RAT may refer to the second RAT. However, example embodiments are not limited to 5G and 6G and may be applied to other radio access technologies. As such, a first RAT and second RAT are not only limited to the examples of 5G and 6G radio access technologies. Hence, it should be understood that example embodiments can be applied to any other current or future radio access technology.

In certain embodiments, the WTRU can receive the Master Information Block (MIB) in the Physical Broadcast Channel (PBCH) transmitted in the SSB, as the SSB may be comprised of synchronization signals and PBCH.

Certain embodiments may include monitoring for SSBs for multiple-RAT cell(s). A WTRU may be (pre)configured, indicated and/or determine to detect and/or receive one or more SSB types. A SSB type may be (pre)configured for and/or associated with one or more of the following: a RAT, carrier type, service type, WTRU device type, WTRU capability, WTRU category, WTRU status, and/or coverage.

A RAT may be a 5G or 6G RAT. Alternatively, a RAT may be any other current or future radio access technology. For example, a 5G RAT SSB may be (pre)configured for and/or associated with a 5G RAT and a 6G RAT SSB may be (pre)configured for and/or associated with a 6G RAT.

In one example, a carrier type may be (pre)configured as 5G carrier, MRSS carrier and/or 6G carrier. A SSB type may be (pre)configured for and/or associated with a carrier type.

A service type may be e.g., eMBB, URLLC, IoT, IIoT with associated service type requirement, service type provide, service geographical area, etc. In one example, a SSB may be (pre)configured for and/or associated with one or more requirements for a service type, e.g., data throughput, latency, reliability, coverage. In another example, a SSB may be (pre)configured for and/or associated with a service type provider identity, e.g. cell-ID, PLMN-ID. In a further example, a SSB may be (pre)configured for and/or associated with a geographical area supported for a service type, e.g., TRP-ID, cell-ID, PLMN-ID, zone-ID.

UE device type, capability, category and/or status. In one example, a SSB may be (pre)configured for and/or associated with a WTRU device type, e.g., Fixed Wireless Access (FWA) WTRU, vehicular WTRU (VUE), handheld WTRU, Reduced Capability (RedCap) WTRU, Low Power Wide Area (LPWA) WTRU, Wearable WTRU. In another example, a SSB may be (pre)configured for and/or associated with WTRU status including, e.g., power saving state and/or battery level.

A SSB may be (pre)configured for and/or associated with a (pre)configured coverage and/or coverage level. In one example, a first SSB may be (pre)configured for and/or associated with a non-enhanced coverage and a second SSB may be (pre)configured for and/or associated with an enhanced coverage. In another example, a set of SSB may be (pre)configured for with each SSB associated with a (pre)configured coverage level.

A WTRU may be (pre)configured with, indicated with and/or determine one or more SSB types, e.g., a first SSB and a second SSB based on one or more of the following: a frequency location with a carrier, a frequency range within a carrier, a transmission bandwidth of SSB, a multiplexing structure of signals and/or channels within a SSB, cell access broadcasting information, sequence of signal(s) in a SSB, and/or cell identity. In one example, the first SSB may be a 5G SSB and the second SSB type may be a 6G SSB.

The frequency location of a SSB type may be the center frequency of the SSB transmission indicated by a Global Synchronization Channel Number (GSCN) and/or Absolute Radio Frequency Channel Number (ARFCN). The GSCN and/or ARFCN may be associated with sync raster and/or absolute frequency raster within a carrier, respectively. In one example, a first SSB's frequency location may be (pre)configured using a sub-set of GSCN and/or ARFCN within a carrier and a second SSB's frequency locations may be (pre)configured using a different sub-set of GSCN and/or ARFCN within the same carrier.

The frequency range of a SSB type may be a bandwidth within a carrier in which the SSB transmission may be (pre)configured. In one example, a first SSB may be (pre)configured to be transmitted within a frequency range over the full bandwidth of a carrier. A second SSB may be (pre)configured to be transmitted within a frequency range (pre)configured in a part of the same carrier. The part of the carrier may include a (pre)configured number of sub-carriers and/or RBs.

A SSB may be (pre)configured with a transmission bandwidth including a number of sub-carrier and/or RBs. In one example, a first SSB be transmitted over a bandwidth of 20 RBs and a second SSB may be transmitted over a bandwidth of 3, 6 or 12 RBs.

A SSB type may include a (pre)configured signal(s) and channels(s), e.g., PSS, SSS and/or PBCH. A SSB type may be (pre)configured and/or associated with a multiplexing structure of the signal(s) and/or channel(s), e.g., time multiplexed only, frequency multiplexed only, time and frequency multiplexed. In addition, the (pre)configured multiplexing structure may indicate the transmission order of the signal(s) and channel(s) within the SSB. A first SSB and second SSB may be (pre)configured with different multiplexing structure.

A SSB may include cell access broadcast information in the SSB transmission, e.g. a PBCH. In one example, a first SSB may indicate a master information block (MIB) to access a 5G cell and a second SSB type may include required information to access a 6G cell. The information may be indicated in one or more of the bit fields of a PBCH. In another example, a MRSS cell indication may be included in a reserved/unused bit field in a 5G PBCH.

A signal and/or channel within a SSB transmission may use a (pre)configured sequence. The sequence may be identified by a sequence type (e.g. Gold sequence, ZC sequence, M sequence), a sequence index and/or a cycle shift. A first and second SSB may use different sequence in e.g., PSS, SSS and/or DMRS of the PBH. In one example, a sequency may be (pre)configured for and/or associated with 5G SSB and another sequence be (pre)configured for and/or associated with 6G SSB.

A SSB may include a cell identity, e.g. a PCI based on PSS and SSS sequences. A first and second SSB may use different sets of PCI. In one example, a 6G SSB may include PCI that may not be included in the PCI set for 5G SSB.

In certain embodiments, a WTRU may be (pre)configured, indicated and/or determine to detect and/or receive first and second SSB types (e.g. 5G SSB and 6G SSB). According to an embodiment, the WTRU may perform a prioritization to select a SSB type for cell access. The prioritization may be based on one more of the following: carrier type, WTRU capability and/or category, service type and/or application, WTRU power saving state or (remaining) battery level, WTRU's geographic location information, and/or WTRU channel conditions and/or coverage level.

According to an embodiment, a WTRU may select a SSB type (pre)configured for and/or associated with carrier within which the WTRU may detect and receive the SSBs. In one example, a WTRU may select 5G SSB for cell access when the WTRU may detect and receive a 5G and 6G SSB in a MRSS carrier.

According to an embodiment, a WTRU may select a SSB type (pre)configured for and/or associated with the capability and/or category of the UE. In one example, a RedCap WTRU may determine to select a detected and received 5G SSB for cell access.

According to an embodiment, a WTRU may select a SSB type (pre)configured for and/or associated with the service type and/or application operated by the WTRU. In one example, a WTRU operating high throughput eMBB service type may select a detected and received 6G SSB for cell access.

According to an embodiment, a WTRU may select a SSB type (pre)configured for and/or associated with a power saving state and/or remaining battery level of the WTRU. In one example, a WTRU in a power saving state (e.g., with reduced WTRU processing and power consumption) may select a detected and received 5G SSB for cell access.

According to an embodiment, a WTRU may determine its own geographic location information based on e.g., GNSS information, zone-ID, cell-ID, TRP-ID, WTRU positioning information. A WTRU may select a SSB type (pre)configured for and/or associated the determined geographic location information. For example, a WTRU may select a 5G SSB when the WTRU may be (pre)configured with 5G cell access at the determined geographic location.

According to an embodiment, a WTRU may select a SSB type (pre)configured for and/or associated with a (pre)configured WTRU channel condition and/or coverage level. The channel condition and/or coverage level may be based on the measurement(s) on a signal (e.g. PSS, SSS, DMRS) and/or a channel (e.g. PBCH) in a SSB. The measurement may include, e.g., RSRP, SINR, RSSI, RSRQ and/or LoS probability. In one example, a WTRU may select a 5G SSB for cell access when WTRU channel condition measurement and/or coverage level may be below a threshold.

Certain embodiments may include multi-RAT spectrum sharing broadcast information. In an embodiment, a WTRU may determine a detected and/or received first SSB may include cell access information related to the second SSB. For example, the cell access information may indicate the cell may support MRSS between 5G and 6G RAT. In this example, a WTRU may receive 6G cell access information (e.g., MRSS) within a detected and received 5G SSB. The information may be included in one or more indication fields (pre)configured in a 5G PBCH, for example, according to one or more of the following: (pre)configured reserved/spare/unused/repurposed indication fields in higher layer payload of a 5G PBCH, e.g., a spare bit in 5G MIB; and/or (pre)configured reserved/spare/unused information indication fields in lower layer payload of a 5G PBCH. In one example, one or more reserved bit(s) for SSB index indication may be used to indicate MRSS support information. In another example, reserved/unused codepoint(s) of the PDCCH configuration indication may be used to indicate the MRSS support information.

In some embodiments, the MRSS support information may include one or more of the following information related to a 6G cell access: SFN, SCS used for the common control signaling (e.g., PDCCH), DMRS configuration for PDCCH reception in CORESET 0, CORESET 0 configuration including the number of symbols and RBs allocated for CORESET 0, search space 0 configuration including the symbols/sub-frame/frame and/or periodicity for monitoring PDCCH in CORESET 0, cell access permission information, and/or SSB index.

Some embodiments may include DL control resource configuration(s) for MRSS cell. In certain embodiments described herein, a first control channel configuration refers to downlink control channel configuration for a first RAT. A second control channel configuration refers to downlink control channel configuration for a second RAT. The downlink control channel configuration can be a search space set configuration, a CORESET configuration, or both. For example, the first control channel configuration can be CORESET #0 and search space set 0 for a first RAT, and the second control channel configuration can be CORESET #0 and search space set O for a second RAT.

According to an embodiment, the WTRU may be configured to determine at least one control channel configuration information of a first RAT by the network.

In one embodiment, the WTRU may receive and/or decode the control channel configuration based on the first indication in MIB, for example, following the cell synchronization procedure via the primary and secondary synchronization blocks. The information received in MIB may include initial instances of the configurations, for example, CORESET #0 and/or search space #0, in order to receive (e.g., initial) system information (e.g., SIB).

In one embodiment, the WTRU may receive and/or decode the control channel configuration via a dynamic signaling (e.g., DCI, MAC-CE) or semi-statically (e.g., via RRC) or via any other lower or higher layer signaling from the network (e.g., SIB1). Such control channel configuration may include other instances of the configuration, for example, CORESET and/or search space configuration, in order to receive the downlink control information (e.g., for uplink or downlink scheduling, control channel monitoring, etc.) from the network.

According to an embodiment, the WTRU may receive the control channel configuration associated with the first RAT with at least a first indication including at least one of the following: time resources, frequency resources, control channel (e.g., PDCCH) candidates configuration, DCI formats, TCI states, DMRS scrambling sequence, and/or precoder granularity.

In an embodiment, the WTRU may receive at least one indication of time resources for control channel configuration associated with the first RAT, such as any one or more of the following: PDCCH monitoring periodicity for monitoring the control channel (e.g., in terms of no. of symbols, slots, subframes and frames) indicating a periodic monitoring behavior for the WTRU, PDCCH monitoring offset for monitoring the control channel (e.g., in terms of no. of symbols, slots, subframes and frames), duration of search space indicating the number of consecutive time resources (e.g., in terms of symbols, slots, subframes, frames) that the WTRU may monitor for PDCCH, indication of which time resources (e.g., in terms of symbols, slots, frames, subframes, etc.) to monitor a group of time resources (e.g., symbol group, slot group, subframe group, frame group, etc.) for PDCCH, and/or time duration of CORESET indicating the total number of (e.g., contiguous) time resources (e.g., in terms of symbols, slots, subframes, frames, etc.) associated with at least one control channel configuration associated with the first RAT.

In an embodiment, the WTRU may receive at least one indication of frequency resources associated with the first RAT, such as one or more of the following: total number of frequency resources (e.g., in terms of RE, RB, etc.), frequency offset of starting frequency resource (e.g., in terms of RE, RB, etc. In one example, the WTRU may receive the offset relative to a configured reference frequency resource, e.g., first frequency resource in a BWP, first frequency resource of the SSB, etc.), indication of frequency resource in terms of a bitmap (e.g., where each bit may represent a group of frequency resources (e.g., in terms of REs, RBs, etc.), where the initial bit may be relative to a configured reference frequency (e.g., first frequency resource in a BWP, first frequency resource of the SSB, etc.), indication of frequency monitoring pattern (for example, in terms of bitmap where each bit may represent a group or a set of frequency resources, e.g., in terms of RBs, REs, etc.) indicating the frequency locations the UE may monitor for PDCCH, CCE-to-REG mapping indicating whether the resources for PDCCH candidates are interleaved or non-interleaved and the associated REG bundle size, interleaver size, etc.

In an embodiment, the WTRU may receive an indication of the at least one of the following: aggregation level (e.g., in terms of no. of CCEs) indication the resources per PDCCH candidate, and/or number of PDCCH candidates to monitor (e.g., per aggregation level).

In an embodiment, the WTRU may receive an indication of at least one DCI format that it may be configured to monitor to receive the downlink control information.

In an embodiment, the WTRU may receive at least one indication of association of the control channel configuration information and at least one TCI state, indicating the relationship between the configuration and at least one reference signal (e.g., downlink or uplink). The TCI state may indicate a quasi-co-location association information indicating the nature of the association (e.g., spatial association, etc.) between the configuration and the reference signal.

In some embodiments, the WTRU may be configured to determine the downlink control channel configuration of a RAT, for example, based on the configuration of downlink control channels of another RAT. For example, the WTRU can be configured with a downlink control channel configuration for a first RAT. The WTRU may then determine the downlink control channel configuration for a second RAT based on the configured downlink control channel of the first RAT. The WTRU may be configured with an additional indication(s) along with the configuration of the downlink control channel configuration of the first RAT to determine the downlink control channel configuration of the second RAT. For example, the WTRU may be configured to receive an additional indication in the Master Information Block (MIB) of the first RAT. In another example, the WTRU may be configured to receive an additional indication(s) in the System Information Block (SIB) of the first RAT. According to certain embodiments, e.g., based on the downlink control channel configuration of the first RAT and the additional indication(s), the WTRU may determine one or more of the following downlink control channel configuration information: time domain configuration of the downlink control channels for the second RAT, frequency domain configuration of the downlink control channels for the second RAT, spatial domain configuration of the downlink control channels for the second RAT, precoder granularity of the CORESET of the second RAT is the same as the precoder granularity of the CORESET of the first RAT, DMRS scrambling sequence initialization of the second RAT is the same as DMRS scrambling sequence initialization of the CORESET of the first RAT, and/or DCI format of in the search space of the second RAT may be associated with the DCI format of the search space configuration of first RAT (e.g., such as the WTRU may be configured to search a PDCCH candidate with a DCI format associated with same or different function (e.g., scheduling, PDCCH monitoring) as the indicated DCI format of the first RAT).

The time domain configuration may include one or more of the following: PDCCH monitoring periodicity, PDCCH monitoring pattern within a slot, duration of the search space set, the slots to monitor PDCCH within group of slots, and/or the time duration of the CORESET of the second RAT.

The WTRU may determine the PDCCH monitoring periodicity of search space set of the second RAT based on the configuration of the PDCCH monitoring periodicity of search space set of the first RAT e.g., the WTRU applies a time offset to the PDCCH monitoring periodicity of the search space set of the first RAT.

The WTRU may determine the PDCCH monitoring pattern within a slot of the search space set of the second RAT using the same monitoring pattern within a slot of the search space set of the first RAT. Alternatively, the WTRU may be configured to shift the monitoring pattern within a slot of the search space set of the first RAT by X symbols to determine the PDCCH monitoring pattern within a slot of the search space set of the second RAT. The value of X can be fixed in the specification or indicated to the WTRU.

The WTRU may determine the duration of the search space set of the second RAT by applying a multiplier to the duration of the search space set of the first RAT. For example, the WTRU may be configured to apply a multiplier value greater than 1 (WTRU then monitors, for longer duration the search space set of the second RAT) or smaller than 1 (WTRU monitors, for shorter duration the search space set of the second RAT) or equal to 1 (WTRU monitors, with the same duration the search space set of the second RAT).

The WTRU may determine the slots to monitor PDCCH candidates of the search space set of the second RAT using the same slots to monitor PDCCH candidates of the search space set of the first RAT. Alternatively, the WTRU may determine a different set of slots to monitor PDCCH candidates of the search space set of the second RAT that are associated with the slots of PDCCH candidates of the search space set of the first RAT. Such associations can be pre-configured to the UE or fixed in the specification (a lookup table).

The WTRU may be configured to determine the time duration of the CORESET of the second RAT (e.g., number of symbols) by applying a multiplier to the time duration of the CORESET of the second RAT.

The frequency domain configuration may include one or more of the following: set of resource blocks (RBs), CCE-to-REG mapping, and/or interleaver size.

The WTRU may determine the start RB of the CORESET for the second RAT using an offset from the start RB of the CORESET for the first RAT. The WTRU may determine the number of RBs of the CORESET for the second RAT by applying a multiplier to the number of RBs of the CORESET for the first RAT (greater/equal/lower than the number of RBs of the CORESET for the first RAT). In an embodiment, the WTRU may be configured to use the remaining RBs from a pre-configured set of RBs, e.g., by excluding the RBs used for the CORESET of the first RAT from the pre-configured set of RBs.

The WTRU may determine the CCE-to-REG mapping the CORESET for the second RAT using the same CCE-to-REG mapping of the CORESET for the first RAT. Alternatively or additionally, the WTRU may be configured with an association between the CCE-to-REG mapping of the CORESET of the first RAT and the CCE-to-REG mapping of the second RAT. The WTRU may determine the CCE-to-REG mapping of the CORESET of the second RAT based on the configured association.

The WTRU may determine the interleaver size of the CORESET for the second RAT using the same interleaver size of the CORESET for the first RAT.

With respect to the spatial domain configuration of the downlink control channels for the second RAT, for example, the WTRU may be configured to use the same TCI states for both CORESETs of the first and second RAT.

As mentioned above, precoder granularity of the CORESET of the second RAT may be the same as the precoder granularity of the CORESET of the first RAT, DMRS scrambling sequence initialization of the second RAT may be the same as DMRS scrambling sequence initialization of the CORESET of the first RAT, and/or DCI format of in the search space of the second RAT may be associated with the DCI format of the search space configuration of first RAT (e.g., the WTRU may be configured to search a PDCCH candidate with a DCI format associated with same or different function (e.g., scheduling, PDCCH monitoring) as the indicated DCI format of the first RAT).

In certain embodiments, after determining the configuration of the downlink control channel of the first RAT, the WTRU may be configured to determine the downlink control channel configuration of the second RAT (e.g., where the configuration includes at least time, frequency and/or spatial information) based on the configuration of the downlink control channel configuration of the first RAT and an indication in the MIB/SIB (or other information block) transmitted in the PBCH/PDSCH of the first RAT. For example, the WTRU may be configured to determine the configuration of CORESET #0 and search space set #0 of the second RAT based on the configuration of CORESET #0 and search space set #0 of the first RAT and an indication in the MIB transmitted in the PBCH of the first RAT. Some of the reserved MIB of the first RAT can be used, by the network, to carry such indication. According to some embodiments, the WTRU may receive in the MIB/SIB, transmitted in the PBCH/PDSCH of the first RAT, an indication of one or more of the following: frequency offset, shared number of PRBs, shared number of symbols, and/or time offset.

According to certain embodiments, the WTRU can receive the indicated parameters above directly in the MIB/SIB or, alternatively, the WTRU may receive a pointer in the MIB/SIB indicating an entry in a list or table fixed in the specification. The WTRU can use the indicated frequency offset (in the MIB/SIB of the first RAT) to determine the frequency start of the downlink control channels of the second RAT relative to the frequency start of the downlink control channels of the first RAT. For example, the WTRU may determine the frequency start of the CORESET #0 of the second RAT by adding the indicated frequency offset to the frequency start of CORESET #0 of the first RAT. The WTRU can use the indicated shared number of PRBs (in the MIB/SIB of the first RAT) to determine the number of PRBs of the downlink control channels of the second RAT. For example, the WTRU may determine the number of PRBs of the CORESET #0 of the second RAT by subtracting the number of PRBs of the CORESET #0 of the first RAT from the shared number of PRBs (indicated in the MIB/SIB of the first RAT). The WTRU can use the indicated shared number of symbols (in the MIB/SIB of the first RAT) to determine the symbol duration of the downlink control channels of the second RAT. For example, the WTRU may determine the symbol duration of the CORESET #0 of the second RAT by subtracting the number of symbols of the CORESET #0 of the first RAT from the shared number of symbols indicated in the MIB/SIB. The WTRU can use the indicated time offset in the MIB/SIB to determine the monitoring occasions of the downlink control channels of the second RAT. For example, the WTRU may determine the monitoring occasions for the search space set #0 of the second RAT by applying the time offset (indicated in the MIB/SIB) to the monitoring occasions of the first RAT search space set #0.

Alternatively or additionally, the WTRU may be configured in the MIB/SIB (transmitted in the PBCH/PDSCH of the first RAT) to use the same parameter(s) of the downlink control channels of the first RAT for the downlink control channels of the second RAT. For example, the WTRU may be configured to use the same number of PRBs for both the CORESETs #0 of the first and second RAT or add a number of PRBs to the number of PRBs of the CORESET #0 of the first RAT.

In some embodiments, the WTRU may receive in the MIB/SIB (transmitted in the PBCH/PDSCH of the first RAT) the downlink control channels configuration of the second RAT. The WTRU may receive a bitfield in the MIB/SIB indicating an entry in a list or table fixed in the specification. Such a table can have multiple downlink control channels configurations for the second RAT.

According to an embodiment, the WTRU may be configured to determine the downlink control channels configuration of the second RAT using an indication in the MIB/SIB and the signalled configuration of the CORESET #0 of the first RAT. For example, the WTRU may determine the CORESET #0 and search space set #0 configuration of the first RAT. The WTRU may be pre-configured (in the specification), with multiple tables, each table corresponds to a CORESET #0 and search space set #0 configuration of the first RAT. The WTRU can use the indicated value in the MIB to determine which row/entry of the table and the row/entry provides the UE with the CORESET #0 and search space set #0 for the second RAT.

In some embodiments, the WTRU may receive the sub-carrier spacing (SCS) configuration for the second RAT using the MIB/SIB transmitted in PBCH/PDSCH of the first RAT. The WTRU may then use the configured SCS to receive the downlink control channels for the second RAT and the WTRU may use the configured SCS to receive the downlink data channels before receiving configuration/reconfiguration from the network.

According to an embodiment, the WTRU may be configured to determine the number of PDCCH candidates for the search space set for the second RAT based on the number of PDCCH candidates configured for the first RAT. The WTRU may be configured with a total number of PDCCH candidates for both the search space set for the first RAT and the search space set of the second RAT. For example, once the WTRU determines the number of PDCCH candidates for the first RAT, the WTRU subtracts the determine number of PDCCH candidates from the total number of PDCCH candidates.

In certain embodiments, the WTRU may monitor (e.g., start to monitor) the downlink control channels for the second RAT using (e.g., based on) the determined configuration described previously. The WTRU may monitor for a PDCCH based on the downlink control channel information, e.g., using the search space set #0 and/or the CORESET #0 of the second RAT and possibly the additional indicated monitoring occasions, if any. For example, the WTRU may start monitoring the PDCCH candidates of the search space set 0 in the CORESET #0 of the second RAT based on the determined monitoring occasions from the MIB/SIB and the search space set 0 configuration of the first RAT.

According to an embodiment, the WTRU may receive the PDCCH in the search space set #0 of the second RAT and/or using the CORESET #0 of the second RAT. Such PDCCH can carry to the WTRU a scheduling assignment of a PDSCH transmission carrying the second RAT cell broadcasted system information (e.g., SIB), second RAT random access response (RAR), second RAT system information update, second RAT paging indication/information, and/or second RAT group common information (e.g., dynamic TDD configuration, slot format configuration, sub-band full duplex configuration).

In some embodiments, the WTRU may be configured to prioritize between monitoring the search space set(s) of the first RAT and the search space set(s) of the second RAT. For example, the UE may be configured with two search space sets, a first search space set within the resources of the first RAT and a second search space set within the resources of the second RAT (e.g., resources including both time and frequency resources). The WTRU may be configured to prioritize between the two search space sets, for example, when one or more of the following occurs: decoding capability of the WTRU is exceeded during a slot/time period (e.g., blind decoding capability of the WTRU within a slot/sub-slot is less than the configured number of PDCCH candidates within the slot/sub-slot or the number of CCEs configured to the WTRU within a slot/sub-slot is larger than the maximum capability of the WTRU within the slot/sub-slot), overlapping monitoring occasions of downlink control channels of the first RAT and second RAT (e.g., the WTRU is configured with a slot/sub-slot/symbol to monitor downlink control channels for both the first RAT and second RAT), and/or the measurements result of reference signals in one of the RATs (e.g., the WTRU is configured with reference signals on the first RAT and second RAT. The WTRU measures the configured RS and when at least one the RSRP of one of the RAT is below a configured threshold, the UE prioritizes monitoring between the search space sets).

According to some embodiments, the WTRU may prioritize monitoring the first search space set (in the first RAT) over the second search space set (in the second RAT) based on one more of the following conditions: number of frequency resources configured for the first search space set is higher than the number of frequency resources configured for the second search space (e.g., the WTRU is configured with higher number of RBs/CCEs for the first search space set compared to the second search space set), the number of frequency resources configured for the CORESET associated with the first search space set is higher than the number of frequency resources configured for the CORESET associated with the second search space (e.g., number of RBs/CCEs is higher), time duration of the first search space set is longer than the time duration of the second search space set, monitoring occasions within X slots of the first search space set is higher than the monitoring occasions of the second search space set, overlapping of the time/frequency resources of the second search space set with high priority signal/channel (e.g., overlapping with the first RAT SSB/5G SSB), and/or the measurement results of the RS configured in the first RAT and/or the measurement result of RS configured in the second RAT (e.g., the WTRU measures RSRP for the configured RS in the second RAT and it is below a configured threshold, while the measured RSRP of the configured RS in the first RAT is above a configured threshold. The WTRU then prioritizes monitoring the search space set in the first RAT).

In some embodiments, the WTRU may prioritize monitoring the second search space set (in the second RAT) over the first search space set (in the first RAT) based on one more of the following conditions: number of frequency resources configured for the second search space set is higher than the number of frequency resources configured for the first search space (e.g., the WTRU is configured with higher number of RBs/CCEs for the second search space set compared to the first search space set), the number of frequency resources configured for the CORESET associated with the second search space set is higher than the number of frequency resources configured for the CORESET associated with the first search space (e.g., number of RBs/CCEs is higher), time duration of the second search space set is longer than the time duration of the first search space set, monitoring occasions within X slots of the second search space set is higher than the monitoring occasions of the first search space set, overlapping of the time/frequency resources of the first search space set with high priority signal/channel (e.g., overlapping with the second RAT SSB/6G SSB), and/or the measurement results of the RS configured in the first RAT and/or the measurement result of RS configured in the second RAT (e.g., the WTRU measures RSRP for the configured RS in the first RAT and it is below a configured threshold, while the measured RSRP of the configured RS in the second RAT is above a configured threshold. The WTRU then prioritizes monitoring the search space set in the second RAT).

Certain embodiments may include inter-RAT DL control signaling. According to some embodiments, the WTRU can be configured to receive downlink control signalling in a first RAT scheduling data reception (i.e., PDSCH transmission) in a second RAT. The WTRU can receive one or more of the following pieces of information in the PDSCH scheduled by the downlink control signalling of the first RAT: random access response (RAR) for RACH transmission in the second RAT, system information update for the second RAT, paging indication/information second RAT, and/or group common information for the second RAT.

According to one example embodiment, the WTRU may be configured to receive a random-access response (RAR) for the second RAT using the downlink control resources/downlink control channels of the first RAT. For example, the WTRU is configured to transmit a PRACH on the uplink resources configured for the second RAR. The WTRU then starts monitoring downlink control resources within downlink resources configured for the first RAT to receive the RAR. In an embodiment, the WTRU may be configured to monitor downlink control resources on the both first RAT and second RAT to receive the RAR.

In one example embodiment, the WTRU may be configured to receive paging message(s) for the second RAT using the downlink control resources/downlink control channels of the first RAT. For example, the WTRU may be configured to monitor downlink control resources within downlink resources configured for the first RAT to receive the paging messages within some paging occasions. The WTRU may be configured to monitor downlink control resources for paging indication on the both first RAT and second RAT.

According to an example embodiment, the WTRU may be configured to determine from the broadcasted information of the first RAT (e.g., MIB or SIB of the first RAT), whether the control signalling for the second RAT can be provided using the control signalling of the first RAT (i.e., control signalling for the second RAT are being transmitted using search space set and CORESET and DCI format configured for the first RAT). For example, the MIB can carry an indication to the WTRU to use the control signalling of the first RAT for all RAT within the MRSS cell. The WTRU can support two different DCI formats during initial access procedure, a first DCI format when control signalling is transmitted in the control resources of the first RAT, and a second DCI format when control signalling is transmitted in the control resources of the second RAT.

In some embodiments, the WTRU may be configured to receive the control signalling for the second RAT using the control signalling of the first RAT prior to the RRC connection establishment. Once the WTRU establishes RRC connection with the network, the WTRU may stop monitoring the control signalling of the first RAT to receive the control signalling for the second RAT.

According to some embodiments, the WTRU may be configured to receive broadcast system information (e.g., MIB and SIB) of the second RAT using the control and/or data transmission of the first RAT.

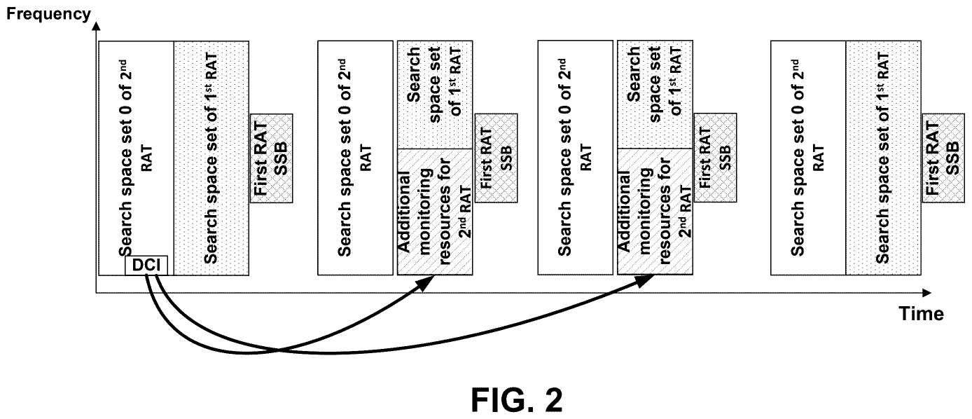

Certain embodiments may provide additional DL control monitoring occasions for MRSS cell. FIG. 2 illustrates an example diagram depicting additional monitoring occasions for the second RAT, according to an embodiment. For example, in some embodiments, the WTRU may be configured with (e.g., receive configuration information indicating) additional monitoring occasions for the downlink control channels configuration of the second RAT. The WTRU can be configured with additional resources for control channels of the second RAT using resources from the first RAT (e.g., resources from CORESET #0/search space set #0 of the first RAT). In one example embodiment, the WTRU may be configured to monitor the search space set of the second RAT (e.g., the search space set #0 of the second RAT) to receive an indication for monitoring additional resources from the CORESET/search space set of the first RAT, for the second RAT. For example, the WTRU may be configured to receive a DCI in the search space set of the second RAT indicating that additional resources are available for monitoring downlink control signalling in the search space set of the second RAT using some of resources of the first RAT, as shown in the example of FIG. 2. In another example, the WTRU may be configured to receive a MAC CE indicating that additional resources are available for monitoring downlink control signalling in the search space set of the second RAT using some of resources of the first RAT.

In some embodiments, the WTRU may be configured to receive an indication for monitoring additional resources from the CORESET/search space set of the first RAT for downlink control resource of the second RAT using an indication in the downlink control resources of the first RAT. For example, the WTRU may be configured to receive a DCI in the search space set of the first RAT indicating that additional resources are available for monitoring downlink control signalling in the search space set of the second RAT using some of resources of the first RAT.

According to some embodiments, the WTRU may be configured to always monitor the additional monitoring occasions for downlink control channels for the second RAT. In another embodiment, the WTRU may be configured to monitor the additional monitoring occasions after (e.g., only after) receiving the indication to monitor the additional monitoring occasions. The WTRU may receive an indication that indicates to the WTRU whether to monitor the additional resources, or to continue monitoring the additional resources or to stop monitoring the additional resources.

According to certain embodiments, the WTRU may be configured to receive an indication of additional resources for additional monitoring occasions indicating one or more of the following: time occasions for additional monitoring resources for the second RAT (e.g., the WTRU may receive an indication in the DCI/MAC indicating one or more of the following for the additional monitoring occasions: PDCCH monitoring periodicity, PDCCH monitoring pattern within a slot, duration of the additional monitoring resources, and/or bitmap indicating the slots to monitor within group of slots), frequency resources for the additional monitoring resources for the second RAT, DCI format(s) to monitor during the additional monitoring resources for the second RAT, and/or number of PDCCH candidates (e.g., the WTRU may be configured with number of PDCCH candidates per aggregation level for the additional monitoring resources for the second RAT).

Upon receiving an indication to monitor additional resources, the WTRU may monitor (e.g., start monitoring) the configured downlink control resources of the second RAT and the additional indicated monitoring occasions.

In some embodiments, the WTRU may be configured to monitor the additional resources for search space set in the second RAT for a pre-configured duration (e.g., a period of time). For example, the WTRU may start a timer when it receives an indication to monitor the additional resources, and upon the timer expiry (e.g., after a certain time period), the WTRU may stop monitoring the additional resources.

In some embodiments, the WTRU may be configured to monitor additional resources for the downlink control channels configuration of the second RAT. The frequency resources of such additional resources can be configured to the WTRU within the control resources of the first RAT. In one embodiment, the WTRU may be configured to use some of the PDCCH candidates of the search space set of the first RAT, to receive control signalling for the second RAT. The downlink control channel(s) for the second RAT, e.g., received by the WTRU in the resource region of the first RAT, can be configured to the WTRU with a different format compared to the downlink control channel(s) received in the resource region of the second RAT (e.g., different DCI format, different DCI size, different aggregation level, different precoding granularity). The WTRU can receive, from the network, the indexes of the PDCCH candidates (from the PDCCH candidates of the first RAT) to use for the second RAT. In an embodiment, the WTRU may be configured to use some of the Control Channel Element (CCE) of the search space set of the first RAT, to receive control signalling for the second RAT. The CCEs for the second RAT, e.g., received by the WTRU in the resource region of the first RAT, can be configured to the WTRU with a different format compared to the CCEs received in the resource region of the second RAT (e.g., different CCE-to-REG mapping, different subcarrier spacing, different number of REGs per CCE). The WTRU can receive, from the network, the indexes of the CCEs to use for the second RAT.

According to some embodiments, the WTRU may be configured with a start RB and the number of RBs to use for additional resources for the downlink control channels configuration for the second RAT. The WTRU may be configured with a start RB, using an indexing starting from the first RB of the control resource set of the first RAT. The WTRU may apply rate matching to decode the PDCCH candidates within the additional resources for the downlink control channels configuration for the second RAT to exclude the resources of the downlink control channels of the first RAT.

In some embodiments, the WTRU may be configured to apply different hashing function to determine the PDCCH candidates of the downlink control channels for the second RAT after the WTRU receives the indication to monitor additional resources. The WTRU may use the hashing function to determine the CCE(s) corresponding to a PDCCH candidate within a search space set. For example, the WTRU is configured to use a first hashing function when the WTRU does not monitor additional resources for downlink control channels for the second RAT. After receiving an indication to monitor additional resources, the WTRU uses a second hashing function to determine the PDCCH candidates on the downlink resources configured for the second RAT and the additional resources indicated from the first RAT.

According to some embodiments, the WTRU may be configured to assume guard band(s) between the resources configured for the first RAT and the resources configured for the second RAT. The guard band(s) can be located within the frequency resources indicated to the WTRU to use for additional resources for the second RAT. The WTRU can receive a configuration of the number of RBs used as guard band between the two control resources. The WTRU may then exclude those resources from PDCCH monitoring and the blind decoding.

In an embodiment, the WTRU may be configured to stop monitoring the downlink control resource for the first RAT after receiving an indication to monitor additional resources for the downlink control for the second RAT.

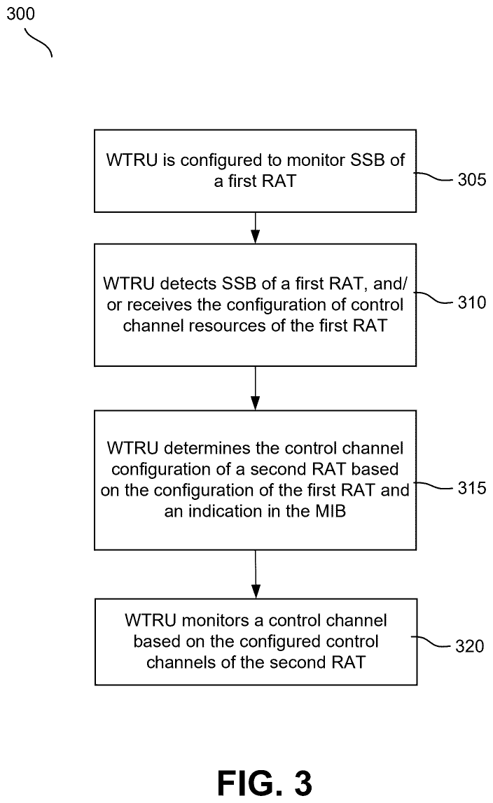

FIG. 3 illustrates a flow diagram of a method 300 for inter-RAT downlink control resource sharing, according to some embodiments. The example method 300 of FIG. 3 and accompanying disclosures herein may include, may be based on, or may be a synthesization of various embodiments or elements discussed in detail above.

For convenience and simplicity of exposition, the example of FIG. 3 may be described with reference to the architecture or system described above with respect to FIGS. 1A-1D, for instance. However, the example method 300 depicted in FIG. 3 may be carried out using different architectures as well. According to some embodiments, the method 300 of FIG. 3 may be performed or implemented by a UE or WTRU, such as the WTRU 102 described in the foregoing with respect to the examples of FIGS. 1A-1D.

It is noted that the method 300 of FIG. 3 may include further steps, procedures or details as discussed in detail elsewhere in this disclosure. As such, the method 300 of FIG. 3 may be modified to include any of the steps, procedures, elements and/or details illustrated and/or discussed in the foregoing or the following. For example, additional details regarding the information, parameters, messages, signaling, configurations, etc. described in FIG. 3 have been discussed in detail above.

Moreover, it is noted that the method and/or blocks of FIG. 3 may be modified to include, or to be replaced by, any one or more of the procedures, elements or blocks discussed elsewhere herein. As such, one of ordinary skill in the art would understand that FIG. 3 is provided as one example and modifications thereto are possible while remaining within the scope of certain example embodiments.

As illustrated in the example of FIG. 3, at 305, the WTRU may be configured to monitor and/or detect a SSB for a first RAT. For example, the WTRU may be configured to detect a SSB associated with a first RAT in a frequency range (e.g., a 6G WTRU is configured to monitor and detect 5G SSB in a frequency range).

In the example of FIG. 3, at 310, the WTRU may detect the SSB of the first RAT, and/or may decode the MIB transmitted in the PBCH within the SSB of the first RAT (or may decode or otherwise determine information from system information (e.g., SIB) as discussed elsewhere herein). The WTRU may determine that the cell associated with the SSB is a MRSS cell (e.g., the WTRU may determine, based on an indication, such as a bitfield indication in the MIB or SIB, that the cell supports MRSS between two RATs, e.g., the cell supports both 5G and 6G using spectrum sharing between them). The WTRU may determine or receive first control channel configuration information associated with the first RAT. For example, the WTRU may receive or determine time and frequency information for receiving a control channel (e.g., CORESET #0 and search space set #0 configuration) of the first RAT based on a first indication in the MIB or SIB.

As illustrated in the example of FIG. 3, at 315, the WTRU may determine second control channel configuration information associated with a second RAT. For example, the WTRU may determine or receive time and frequency information for receiving a control channel (e.g., configuration of CORESET #0 and search space set #0) of the second RAT based on the first control channel configuration information (of the first RAT) and a second indication in the MIB or SIB. For example, the second indication in the MIB or SIB may indicate any one or more of (e.g., directly or by providing a pointer to an entry in a list or table): a frequency offset, a shared number of PRBs, a shared number of symbols, and/or a time offset.

For example, the WTRU may determine the frequency start of an initial CORESET associated with the second RAT based on the frequency start of the initial CORESET associated with the first RAT (e.g., the WTRU may determine the frequency start of the second RAT CORESET #0 by adding an offset (e.g., the frequency offset) to the frequency start of the first RAT CORESET #0).

For example, the WTRU may determine the number of PRBs of an initial CORESET associated with the second RAT based on the number of PRBs of an initial CORESET associated with the first RAT (e.g., the WTRU determines the number of PRBs of the second RAT CORESET #0 by subtracting the number of PRBs of the first RAT CORESET #0 from the shared number of PRBs).

For example, the WTRU may determine the symbol duration of an initial CORESET associated with the second RAT based on the number of symbols of the initial CORESET associated with the first RAT and the shared number of symbols (e.g., the WTRU determines the symbol duration of the second RAT CORESET #0 by subtracting the number of symbols of the first RAT CORESET #0 from the shared number of symbols).

For example, the WTRU may determine the monitoring occasions for the initial search space associated with the second RAT based on a time offset and the monitoring occasions associated with the initial search space set associated with the first RAT (e.g., the WTRU may determine the monitoring occasions for the second RAT search space set #0 by applying the time offset to the monitoring occasions of the first RAT search space set #0).

In the example of FIG. 3, at 320, the WTRU may monitor for a control channel (e.g., PDCCH) based on the second control channel information (e.g., using the second RAT search space set #0 and/or the second RAT CORESET #0). In some embodiments, the WTRU may additionally monitor the control channel based on the additional indicated monitoring occasions, if any, as discussed above. The WTRU may receive a control channel transmission (e.g., PDCCH transmission in the second RAT search space set #0 and/or using the second RAT CORESET #0).

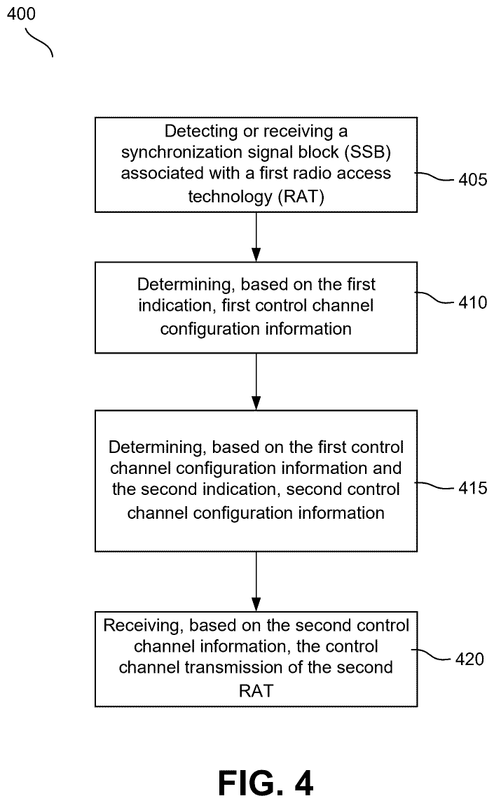

FIG. 4 illustrates a flow diagram of a method 400 for inter-RAT downlink control resource sharing, according to some embodiments. The example method 400 of FIG. 4 and accompanying disclosures herein may include, may be based on, or may be a synthesization of various embodiments or elements discussed in detail above.

For convenience and simplicity of exposition, the example of FIG. 4 may be described with reference to the architecture or system described above with respect to FIGS. 1A-1D, for instance. However, the example method 400 depicted in FIG. 4 may be carried out using different architectures as well. According to some embodiments, the method 400 of FIG. 4 may be performed or implemented by a UE or WTRU, such as the WTRU 102 described in the foregoing with respect to the examples of FIGS. 1A-1D.

It is noted that the method 400 of FIG. 4 may include further steps, procedures or details as discussed in detail elsewhere in this disclosure. As such, the method 400 of FIG. 4 may be modified to include any of the steps, procedures, elements and/or details illustrated and/or discussed in the foregoing or the following. For example, additional details regarding the information, parameters, messages, signaling, configurations, etc. described in FIG. 4 have been discussed in detail above.

Moreover, it is noted that the method and/or blocks of FIG. 4 may be modified to include, or to be replaced by, any one or more of the procedures, elements or blocks discussed elsewhere herein. As such, one of ordinary skill in the art would understand that FIG. 4 is provided as one example and modifications thereto are possible while remaining within the scope of certain example embodiments.

As illustrated in the example of FIG. 4, the method 400 may include, at 405, detecting or receiving a synchronization signal block (SSB) associated with a first radio access technology (RAT). For example, the SSB may be received from a cell or network node that supports MRSS between a first RAT and second RAT. In an embodiment, the method 400 may include determining, based on cell access information in the SSB, that the cell from which the SSB is received supports MRSS between a first and second RAT.

According to some embodiments, the method 400 may include determining or obtaining, based on the SSB, a first indication and a second indication (e.g., determine, based on information included in or associated with the SSB, the first and second indications). For example, the first indication and/or second indication may be included, indicated or otherwise obtained from a MIB or SIB, as discussed elsewhere herein. In an embodiment, the determining or obtaining of the first indication and the second indication may include decoding an information block (e.g., MIB or SIB) included in the SSB associated with the first RAT.

As shown in the example of FIG. 4, the method 400 may include, at 410, determining, based on the first indication, first control channel configuration information associated with receiving a control channel transmission of the first RAT.

In the example of FIG. 4, the method 400 may include, at 415, determining, based on the first control channel configuration information and the second indication, second control channel configuration information associated with receiving a control channel transmission of the second RAT.

As illustrated in the example of FIG. 4, the method 400 may include, at 420, receiving, based on the second control channel information, the control channel transmission of the second RAT. For example, the control channel transmission may be a PDCCH transmission or a transmission associated with another type of control channel.

In some embodiments, for example, the first RAT may be a 5G RAT and the second RAT may be a 6G RAT. However, this is merely one example and, as discussed above, example embodiments are not limited to 5G and 6G RATs and could be applicable to any other current or future radio access technologies.

According to an embodiment, the first control channel configuration information may include time and/or frequency information associated with receiving the control channel transmission of the first RAT, and/or the second control channel configuration information may include time and/or frequency information associated with receiving the control channel transmission of the second RAT.

In an embodiment, the time and/or frequency information associated with receiving the control channel transmission of the first RAT may include CORESET and search space set configuration information associated with the first RAT, and/or the time and/or frequency information associated with receiving the control channel transmission of the second RAT may include CORESET and search space set configuration information associated with the second RAT.

According to an embodiment, the determining of the second control channel configuration information, at 415, may include any one or more of: determining a frequency start of the CORESET associated with the second RAT based on an offset from a frequency start of the CORESET associated with the first RAT, determining a number of PRBs of the CORESET associated with the second RAT based on a number of PRBs of the CORESET associated with the first RAT and a shared number of PRBs, determining a symbol duration of the CORESET associated with the second RAT based on a number of symbols of the CORESET associated with the first RAT and a shared number of symbols, and/or determining monitoring occasions for the search space set associated with the second RAT based on a time offset from monitoring occasions for the search space set associated with the first RAT.

In an embodiment, the control channel transmission of the second RAT may be received in the search space set associated with the second RAT and/or may be received using the CORESET associated with the second RAT.

In some embodiments, the second indication may indicate any one or more of: a frequency offset, a shared number of physical resource blocks (PRBs), a shared number of symbols, and/or a time offset.

According to an embodiment, receiving the control channel transmission of the second RAT, at 420, may include monitoring a downlink control channel associated with the second RAT.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

In some example embodiments described herein, (e.g., configuration) information may be described as received by a WTRU from the network, for example, through system information or via any kind of protocol message. Although not explicitly mentioned throughout embodiments described herein, the same (e.g., configuration) information may be pre-configured in the WTRU (e.g., via any kind of pre-configuration methods such as e.g., via factory settings), such that this (e.g., configuration) information may be used by the WTRU without being received from the network.

Any characteristic, variant or embodiment described for a method is compatible with an apparatus device comprising means for processing the disclosed method, such as with a device comprising a processor configured to process the disclosed method, a computer program product comprising program code instructions and a non-transitory computer-readable storage medium storing program instructions.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. §112, ¶6 or means-plus-function claim format, and any claim without the terms “means for” is not so intended.

Although various embodiments have been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although some example embodiments are illustrated and described herein, the invention is not intended to just be limited to the details shown. Rather, various modifications and variations may be made in the details within the scope and range of equivalents of the claims and without departing from the spirit or scope invention.

### ACRONYMS AND ABBREVIATIONS

The following abbreviations or acronyms may have been referred to hereinabove:
ACK Acknowledgement
BWP Bandwidth Part
BSR Buffer Status Report
CG Configured grant or cell group
CCE Control channel element
CP Cyclic Prefix
CP-OFDM Conventional OFDM (relying on cyclic prefix)
CQI Channel Quality Indicator
CRC Cyclic Redundancy Check
CSI Channel State Information
DCI Downlink Control Information
DL Downlink
DMRS Demodulation Reference Signal
HARQ Hybrid Automatic Repeat Request
LCH Logical Channel
LCG Logical Channel Group
MCS Modulation and Coding Scheme
MIB Master Information Block
MRSS Multi-RAT Spectrum Sharing
NACK Negative ACK
NR New Radio
OFDM Orthogonal Frequency-Division Multiplexing
PBCH Physical Broadcast Channel
PDCCH Physical Downlink Control Channel
PDSCH Physical Downlink Shared Channel
PHY Physical Layer
PRB Physical Resource Block
PUCCH Physical Uplink Control Channel
PUSCH Physical Uplink Shared Channel
RAT Radio Access Technology
REG Resource Element Group
RB Resource Block
RNTI Radio Network Identifier
RRC Radio Resource Control
RS Reference Signal
RSRP Reference Signal Received Power
RSSI Received Signal Strength Indicator
SBFD Sub-band Full Duplex
SCS Sub carrier spacing
SIB System Information Block
SRS Sounding Reference Signal
SPS Semi-persistent scheduling
SS Search Space
SSB Synchronization Signals Block
TB Transport Block
TBS Transport Block Size
TRP Transmission/Reception Point
UE User Equipment
UL Uplink
URLLC Ultra-Reliable and Low Latency Communications.

1. A wireless transmit/receive unit (WTRU), comprising:
circuitry, including any of a processor and transceiver, configured to detect a synchronization signal block (SSB) associated with a first radio access technology (RAT);
determine, based on the SSB, a first indication and a second indication;
determine, based on cell access information indicated in the SSB, that a cell from which the SSB is received supports multi-RAT spectrum sharing between the first RAT and a second RAT;
determine, based on the first indication, first control channel configuration information associated with receiving a control channel transmission of the first RAT;
determine, based on the first control channel configuration information and the second indication, second control channel configuration information associated with receiving a control channel transmission of the second RAT; and
receive, based on the second control channel information, the control channel transmission of the second RAT.

2. The WTRU of claim 1, wherein, to determine the first indication and the second indication, the WTRU is configured to decode an information block included in the SSB associated with the first RAT.

3. The WTRU of claim 1, wherein the first RAT comprises a 5G RAT and the second RAT comprises a 6G RAT.

4. The WTRU of claim 1, wherein the first control channel configuration information comprises time and frequency information associated with receiving the control channel transmission of the first RAT, and wherein the second control channel configuration information comprises time and frequency information associated with receiving the control channel transmission of the second RAT.

5. The WTRU of claim 4, wherein the time and frequency information associated with receiving the control channel transmission of the first RAT comprises control resource set (CORESET) and search space set configuration information associated with the first RAT, and wherein the time and frequency information associated with receiving the control channel transmission of the second RAT comprises control resource set (CORESET) and search space set configuration information associated with the second RAT.

6. The WTRU of claim 5, wherein, to determine the second control channel configuration information, the WTRU is configured to any of:
determine a frequency start of the CORESET associated with the second RAT based on an offset from a frequency start of the CORESET associated with the first RAT;
determine a number of physical resource blocks (PRBs) of the CORESET associated with the second RAT based on a number of PRBs of the CORESET associated with the first RAT and a shared number of PRBs;
determine a symbol duration of the CORESET associated with the second RAT based on a number of symbols of the CORESET associated with the first RAT and a shared number of symbols; and
determine monitoring occasions for the search space set associated with the second RAT based on a time offset from monitoring occasions for the search space set associated with the first RAT.

7. The WTRU of claim 5, wherein the control channel transmission of the second RAT is any of: received in the search space set associated with the second RAT and/or using the CORESET associated with the second RAT.

8. The WTRU of claim 1, wherein the second indication indicates any of: a frequency offset, a shared number of physical resource blocks (PRBs), a shared number of symbols, and/or a time offset.

9. The WTRU of claim 1, wherein the control channel transmission comprises a physical downlink control channel (PDCCH) transmission.

10. The WTRU of claim 1, wherein, to receive the control channel transmission of the second RAT, the WTRU is configured to monitor a downlink control channel associated with the second RAT.

11. A method, implemented by a wireless transmit/receive unit (WTRU), the method comprising:
detecting a synchronization signal block (SSB) associated with a first radio access technology (RAT);
determining, based on the SSB, a first indication and a second indication;
determining, based on cell access information indicated in the SSB, that a cell from which the SSB is received supports multi-RAT spectrum sharing between the first RAT and a second RAT;
determining, based on the first indication, first control channel configuration information associated with receiving a control channel transmission of the first RAT;
determining, based on the first control channel configuration information and the second indication, second control channel configuration information associated with receiving a control channel transmission of the second RAT; and
receiving, based on the second control channel information, the control channel transmission of the second RAT.

12. The method of claim 11, wherein the determining of the first indication and the second indication comprises decoding an information block included in the SSB associated with the first RAT.

13. The method of claim 11, wherein the first RAT comprises a 5G RAT and the second RAT comprises a 6G RAT.

14. The method of claim 11, wherein the first control channel configuration information comprises time and frequency information associated with receiving the control channel transmission of the first RAT, and wherein the second control channel configuration information comprises time and frequency information associated with receiving the control channel transmission of the second RAT.

15. The method of claim 14, wherein the time and frequency information associated with receiving the control channel transmission of the first RAT comprises control resource set (CORESET) and search space set configuration information associated with the first RAT, and wherein the time and frequency information associated with receiving the control channel transmission of the second RAT comprises control resource set (CORESET) and search space set configuration information associated with the second RAT.

16. The method of claim 15, wherein determining the second control channel configuration information comprises any of:
determining a frequency start of the CORESET associated with the second RAT based on an offset from a frequency start of the CORESET associated with the first RAT;
determining a number of physical resource blocks (PRBs) of the CORESET associated with the second RAT based on a number of PRBs of the CORESET associated with the first RAT and a shared number of PRBs;
determining a symbol duration of the CORESET associated with the second RAT based on a number of symbols of the CORESET associated with the first RAT and a shared number of symbols; and
determining monitoring occasions for the search space set associated with the second RAT based on a time offset from monitoring occasions for the search space set associated with the first RAT.

17. The method of claim 15, wherein the control channel transmission of the second RAT is any of: received in the search space set associated with the second RAT and/or using the CORESET associated with the second RAT.

18. The method of claim 11, wherein the second indication indicates any of: a frequency offset, a shared number of physical resource blocks (PRBs), a shared number of symbols, and/or a time offset.

19. The method of claim 11, wherein the control channel transmission comprises a physical downlink control channel (PDCCH) transmission.

20. The method of claim 11, wherein receiving the control channel transmission of the second RAT comprises monitoring a downlink control channel associated with the second RAT.
